(19) United States
(12) Patent Application Publication
(10) Pub. No.: US 2008/0303806 A1
(43) Pub. Date: Dec. 11, 2008

(54) Automatic Illuminance Compensation in Displays

(76) Inventor: Richard Charles Perrin, Stuvenborn (DE)

Correspondence Address: PHILIPS INTELLECTUAL PROPERTY & STANDARDS, P.O. BOX 3001, BRIARCLIFF MANOR, NY, 10510, US

(21) Appl. No.: 12/097,533

(22) PCT Filed: Dec. 13, 2006
(86) PCT No.: PCT/IB06/54803

§ 371 Date: Jun. 14, 2008

(30) Foreign Application Priority Data
Dec. 22, 2005 (EP) 05112726.4

(51) Int. Cl. G09G 5/00

(52) U.S. Cl. 345/207

(57) ABSTRACT

A sensor for continuously measuring the illuminance of ambient light (112) falling on a display. The sensor comprises a photo-sensitive device (100) and a diffuser (110), and conforms reasonably closely to the cosine effect. The proposed sensor performs like an illuminance meter and provides an illuminance measurement for use in continuously adjusting the grey scale transfer function of the display to maintain calibration thereof to a target transfer function and thereby to compensate for the above-mentioned illuminance.

The invention relates generally to automatic illuminance control in display screens used in, for example, X-ray imaging systems.

Illuminance is defined as the luminous flux incident on a given surface per unit area, and is measured in lux. It is well known to provide a form of automatic brightness control in respect of displays used in X-ray modalities, for example, in an attempt to compensate for illuminance caused by ambient light falling on the display.

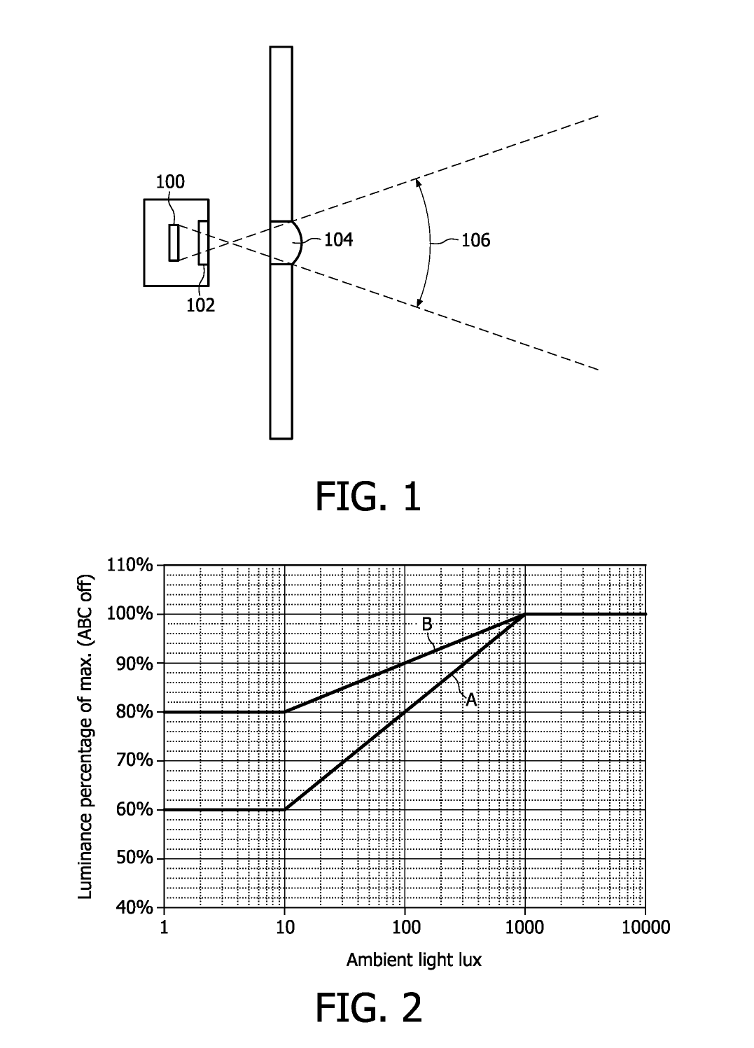

Referring to FIG. 1 of the drawings, one system for sensing ambient light in respect of a cathode ray tube (CRT) display, comprises a photo-sensitive device 100 and photoptic filter 102 located behind a plain, transparent window 104 in a display screen. The amount of light detected by the photo-sensitive device is used as a measure of the illuminance of ambient light falling on the display by an automatic brightness control module that adjusts the contrast and/or brightness settings of the display proportionally to the logarithm of the measured illuminance so as to compensate for the light that will be reflected from the display.

The general form of the control algorithm used by the above-mentioned control module is:

A=a₁+a₂·log(i_{abc}) and B=b₁+b₂·log(i_{abc})

The luminance (defined as the luminance intensity per unit solid angle) l=(A+B.V)^{γ} where V is the video input signal and the transfer functions A and B are defined graphically in FIG. 2 of the drawings, where transfer function A represents a reduced automatic brightness control (ABC) and transfer function B represents a so-called “normal” ABC. The control parameters conventionally used include the maximum comfortable viewing luminance at a given illuminance and display “flicker” perception, which parameters would have been based on a series of observer perception tests.

However, referring back to FIG. 1 of the drawings, the light incident on the photo-sensitive device 100 is collimated to a certain extent and the system has a distinct field of view 106 which tends to be of the order of 30° to 45°. As a result, the system tends to measure luminance coming from some target, e.g. a surgeon's coat, rather than the illuminance of the ambient light falling on the display. This means that the illuminance measurement used by the control algorithm adjust the contrast and/or brightness settings of the display is not a real representation of the light that will be reflected by the display, but is instead influenced by other secondary effects in the vicinity of the display.

In any event, liquid crystal displays (LCDs) have an entirely different display structure than the CRT-based display. This difference in structure has a number of consequences when considering the implementation of automatic illuminance control, as set out in detail by Hartwig Blume, et al in “Practical aspects of greyscale calibration of display systems”, Proceedings of SPIE Vol. 4323 (2001), pp. 28-35.

One of the main considerations to be taken into account with respect to LCDs is the requirement to conform to the “Digital Imaging and Communication in Medicine” (DICOM) Display Function Standard, which will be well known to a person skilled in the art. It is a standard developed to define the connectivity and communication protocols of medical imaging devices. The DICOM Display Function Standard defines mathematically a function for the relation between digital input and luminance of an image display system and thereby provides an objective method for a predictable and reproducible greyscale rendition of monochrome images, and it facilitates subjective similarity in greyscale rendition between different display devices independent of their luminance range. This standard requires the use of the DICOM test pattern with a central measurement field and fixed background to properly consider veiling glare in the display. As a result of this factor, among others, automatic illuminance technique described above, which was developed for CRT-based displays, is not thought to be ideal for LCDs.

It is therefore an object of the present invention to provide a system and method for automatic illuminance control that can be effectively implemented in liquid crystal display devices.

In accordance with the present invention, there is provided apparatus for sensing illuminance of ambient light falling on a display, said apparatus comprising a photo-sensitive device located behind said display for receiving light falling on said display and generating an electric signal representative thereof, and a diffuser located between a source of said ambient light and said photo-sensitive device.

When a plain transparent window is used as in the prior art, the geometry of the physical location of the sensor with respect to the aperture and the optical properties (diffraction) of the window is a limiting factor in that the resultant measurement is not representative of the amount of ambient light that is influencing the display and there is a tendency for over-reaction to small changes directly in front of the monitor, e.g. movements of the viewer.

On the contrary, the above-mentioned object is achieved by using a diffuser in place of the plain, transparent window used in the system according to the prior art, because the diffuser is able to collect the light available from a complete hemisphere, satisfying the requirement to measure illuminance. The sensor behind the display is no longer influenced by the direction that any particular light beam is coming from. In this way, the measurement will more closely represent the amount of light falling on the display, and in turn the amount of luminance due to the ambient light that will need to be corrected for.

In a preferred embodiment, the apparatus is arranged and configured to conform substantially to the cosine effect whereby the illuminance on said display varies as the cosine of the angel of light incident thereon. Preferably the diffuser is mounted in a substantially planar structure behind which said photo-sensitive device is located. The diffuser may be mounted proud (by a distance δ) relative to the surface of said planar structure, wherein a substantially annular ring is preferably provided around said photo-sensitive device at a height 6 relative thereto. Alternatively, the diffuser may be substantially flush relative to the surface of said planar structure, or it may be located within an opaque tubular structure, such that the illuminance measurement about the angle of incidence of light (θ)=0 is substantially zero.

Preferably, the diffuser and photo-sensitive device are located generally centrally relative to a viewing area of said display.

The present invention extends to a system for automatic illuminance control in respect of a display for displaying an image comprising a plurality of values representing pixel grey scale levels, said system comprising apparatus as defined above for generating an electric signal representative of the illuminance of ambient light falling on said display, and a control module for adjusting the grey scale transfer function of said display so as to maintain calibration of a target grey scale transfer function.

Beneficially, said calibration of said target transfer function is dictated by a standard such as DICOM, and the grey scale transfer function is preferably adjusted substantially continuously.

The video input signal defining said plurality of values may be digital or analogue. In a preferred embodiment, the grey scale transfer function is adjusted by adjusting one or more of the contrast and brightness in an analogue display and the backlight luminance and look up table (LUT) is a digital display.

The display may be a CRT-based or liquid crystal display.

The present invention extends further to a display device comprising a display screen and a system as defined above, and to an image processor for use with a display screen for displaying an image comprising a plurality of values representing pixel grey scale values, said image processor being arranged and configured to receive from apparatus as defined above an electric signal representative of the illuminance of ambient light falling on said display screen and further comprising a control module for adjusting the grey scale transfer function of said display screen so as to maintain calibration of a target grey scale transfer function.

These and other aspects of the present invention will be apparent from, and elucidated with reference to, the embodiments described herein.

Embodiments of the present invention will now be described by way of examples only with reference to the accompanying drawings, in which:

FIG. 1 is a schematic diagram illustrating the principal components of a system according to the prior art for sensing ambient light falling on a display;

FIG. 2 illustrates graphically the transfer functions used by the control algorithm of an automatic brightness control system according to the prior art;

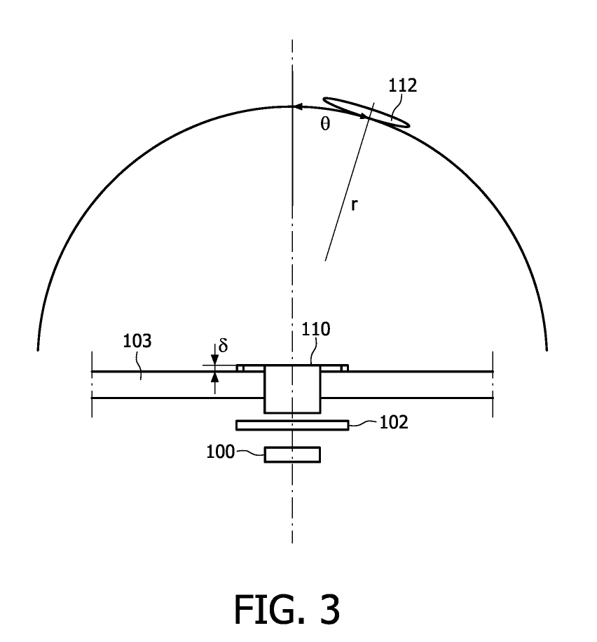

FIG. 3 is a schematic diagram illustrating the principal components of an illuminance sensor according to an exemplary embodiment of the present invention;

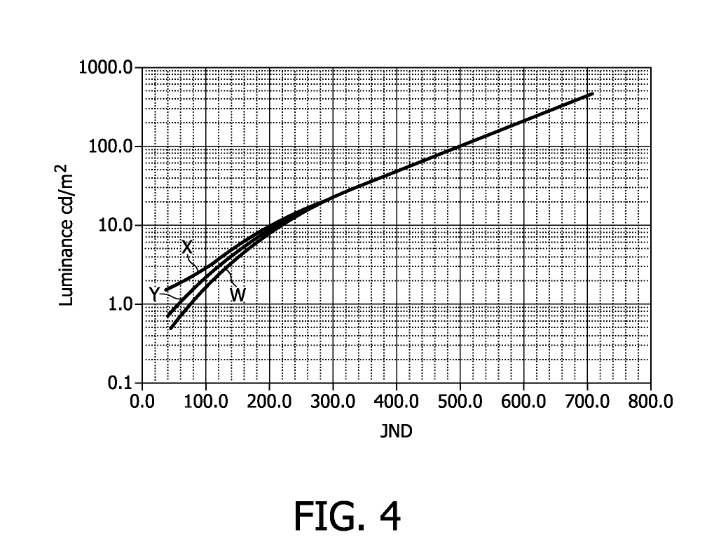

FIG. 4 is a graphical representation of the effect of ambient light in a grey scale transfer function (GTF);

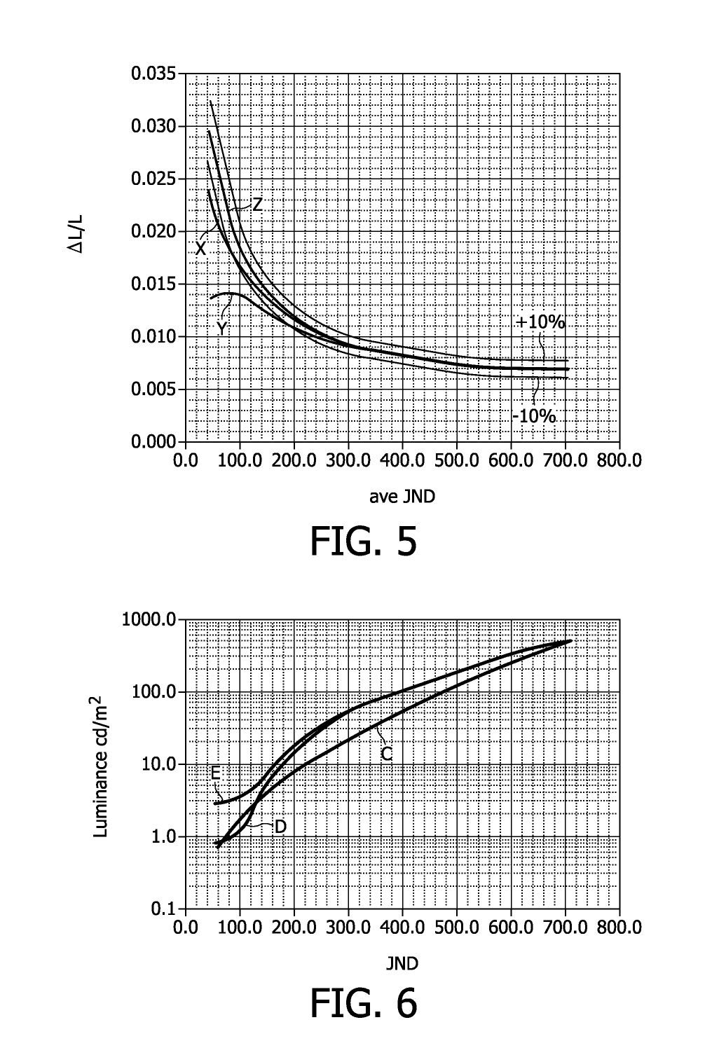

FIG. 5 is a graph representing the effect of 20 lₓ and 100 lₓ illuminance on ΔL/L;

FIG. 6 is a graphical representation of an uncorrected LCD transfer function;

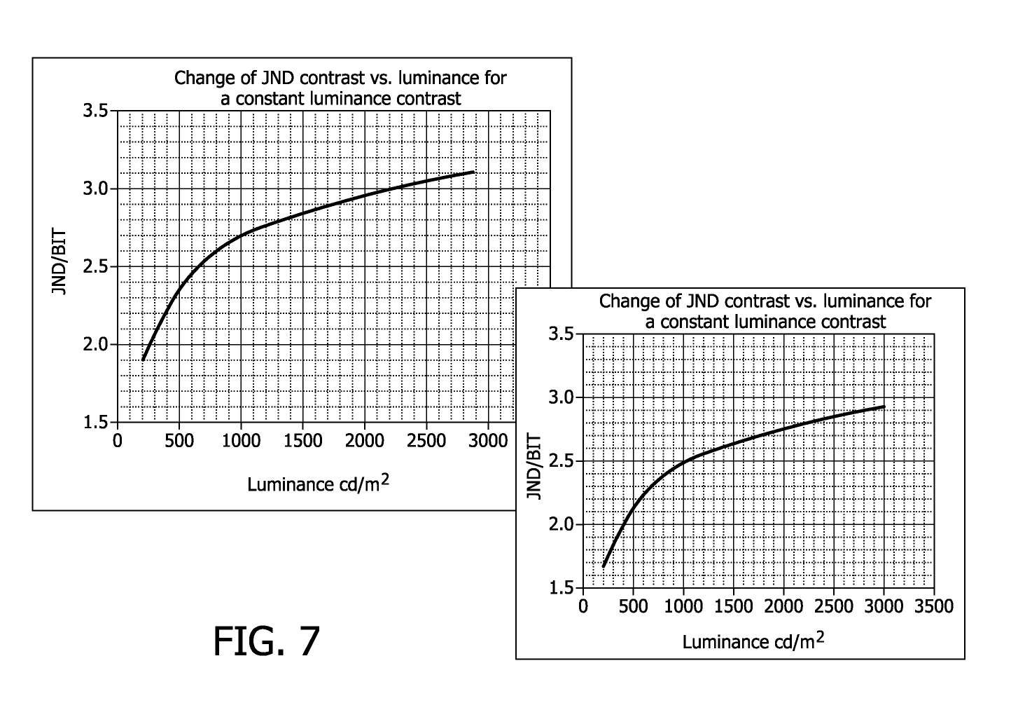

FIG. 7 is a graphical representation of a change of JND contrast vs luminance for constant luminance contrast;

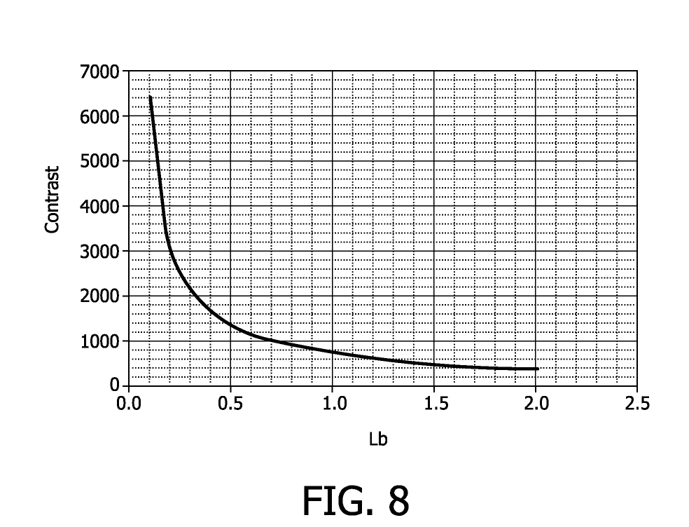

FIG. 8 represents graphically the relationship of contrast with black level for a CRT display;

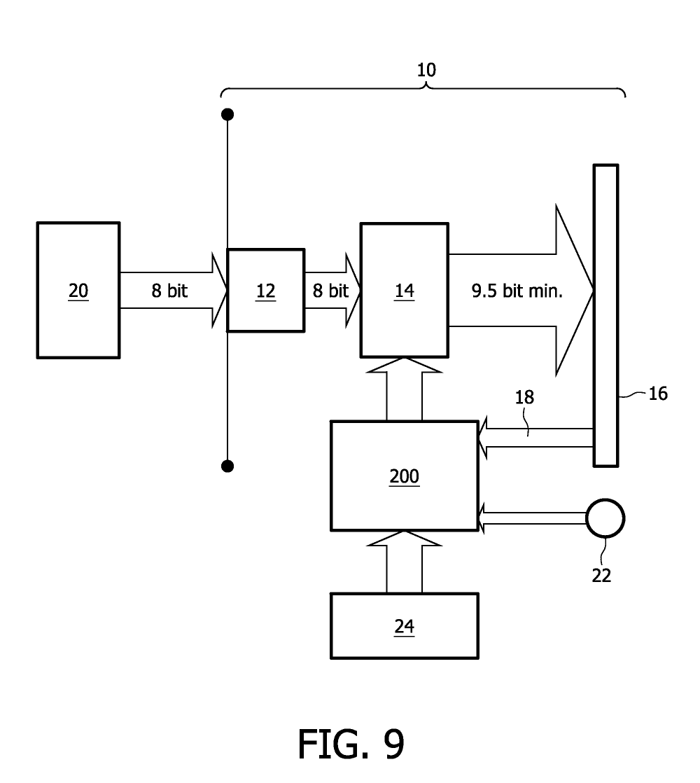

FIG. 9 is a schematic block diagram of an LCD system according to a first exemplary embodiment of the present invention; and

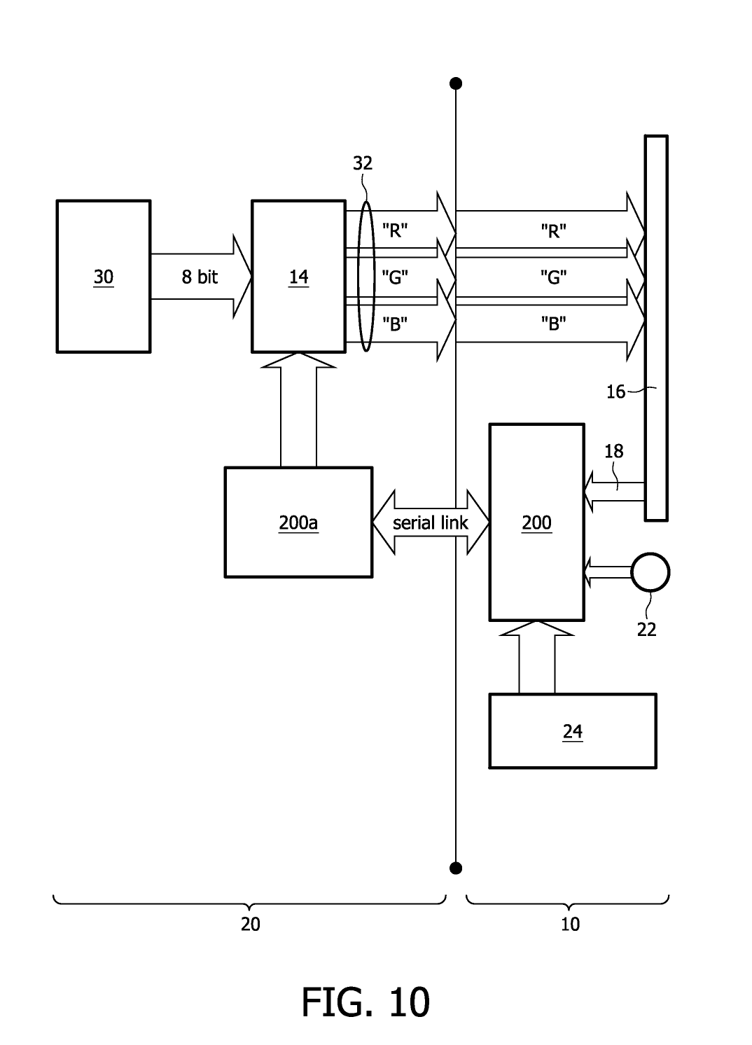

FIG. 10 is a schematic block diagram of an LCD system according to a second exemplary embodiment of the present invention.

As explained above, the illuminance sensor used in prior art automatic brightness control systems tends to react to the luminance of targets in front of the display as well as the illuminance of ambient light falling on the display. In order to overcome this problem, as well as achieve the above-mentioned object of the invention, the illuminance sensor is reconfigured in an exemplary embodiment of the present invention, relative to CRT systems, so as to be having more like an illuminance meter (rather than a luminance sensor).

Referring to FIG. 3 of the drawings, a system for sensing illuminance according to an exemplary embodiment of the present invention comprises a photo-sensitive device 100 and photoptic filter 102 positioned generally centrally behind a bezel 103 which is simply the monitor frame. A diffuser 110 is provided within the bezel 103, in place of the transparent window employed in the prior art system described with reference to FIG. 1. The design does not have to be too accurate, but it should conform reasonably closely to the cosine effect, which states that the illuminance on a surface varies as the cosine of the angle of incidence of the light.

In the illustrated example, the diffuser 110 is slightly proud of the surface, by a distance δ. In this case, it is desirable to provide an annular ring (not shown) around the sensor 100, at the same height relative thereto as the height δ of the diffuser above the surface of the bezel 103, so as to ensure a zero result at θ=90°. Alternatively, the diffuser 110 may be substantially flush with the surface of the bezel 103, or located within an opaque tube.

$$E = \frac{LA}{{r}^{2}} cos θ$$

### Where:

E=The illuminance

L=The luminance of a remote light source of area A

r=The distance from the sensor to the light source

θ=The angel of the light source from the normal axis of the sensor

r=\sqrt{A}

In general, all displays reflect light 112 from the environment to the observer. This is always the case, even in a totally dark room, because in that case the self-luminance of the display is reflected back from the walls of the room and from clothing and skin.

The effect of this is to increase the effective black level of the display that the observer can see, reducing the local contrast ΔL/L in the dark areas of the display. Consider the following example:

A display has an ambient reflectance p of 0.01 cd/m²/Lx and the display has been calibrated to conform to the known DICOM 3.14 grey-scale transfer function under dark conditions.

The graph of FIG. 4 shows the effect of the ambient reflectance on the transfer function.

It is assumed that:

The black level L_{bd} set to 0.5 cd/m²

The white level that is stabilised to 500 cd/m²

The display is illuminated by a diffuse light source of Iₐ=100 LUX

Then the effective black level L_{be} will be:

L_{be}=p·Iₐ+L_{bd}=1.5 cd/m²

The GTF (Greyscale Transfer Function) without any influence from ambient light is shown by the curve denoted ‘W’. The curve denoted ‘X’ shows the actual GFT with 100 LUX illuminance.

The curve denoted ‘Y’ shows the effect of a very modest illuminance of 20 LUX.

It is recommended that the greyscale transfer function is assessed by looking at the local contrast (ΔL/L) rather than luminance. This is essentially the first derivative of the luminance curve. The conformance to the required target GTF is within ±10% for a class one device.

The graph of FIG. 5 shows the effect of 20 lx and 100 lx on ΔL/L.

The ±10% tolerance lines relative to the “calibrated” target curve ‘Z’ represent the tolerance suggested for class 1 devices. It can be seen that even a very modest change of ambient light will result in a monitor no longer being in calibration. Once again, the curve denoted ‘X’ represents 100 LUX illuminance and the curve denoted ‘Y’ represents illuminance of 20 LUX.

The result here is based on a screen ambient reflectance factor Pₐ of 0.007, which is typical for an LCD Display.

This effect is very well known and is of course the reason for including the ambient conditions in display calibrations.

Rather than implementing the ABC schemes from prior art CRT designs, it is preferred to adapt the display transfer function for this exemplary embodiment of the invention, such that calibration is retained regardless of changes of illuminance.

For an LCD, the variables that are potentially available to control are:

The back light luminance;

The LUT (Look Up Table).

By controlling the back light luminance it is possible to control the black luminance and white luminance of the display remembering that:

$$\frac{{L}_{{p}_{max}}}{{L}_{{p}_{min}}} = C {R}_{max}$$

The maximum contrast ratio for an LCD is often not adjustable

With the LUT it is possible to control both the grey scale transfer function and the dynamic range.

Assuming that the following features for a display are known:

The transmittance of the LCD with the LUT set linear (data in=data out);

The back light luminance;

The ambient reflectance factor Pₐ;

It is possible to calculate the display luminance transfer function for the uncorrected case.

The transfer function of an LCD is an arbitrary function and does not lend itself to mathematical modelling. The device has to be measured and the transmittance result stored as a table. For convenience, the following expression will be used herein:

T_{icd}=ƒ_{lcd}(D)

### Where

θ_{lcd}=the arbitrary function of the LCD

D=the Display data value (The display data is the output data at the output of the display LUT in the host system).

If the back light Luminance is L_{bl} Then

L_{lcd}=L_{bl}·ƒ_{lcd}(D)

When the illuminance in the display environment is Iₐ.

Lₐ=IₐPₐ

The Resulting displayed luminance for and given data input D is clearly:

L_{d}=L_{bl}·ƒ_{lcd}(D)+Iₐ·Pₐ

An example of an uncorrected LCD transfer function is shown in FIG. 6:

Curve C—DICOM
D—uncorrected panel
E—panel with illuminance Lₐ

The process for calibration to the known DICOM 3.14 luminance transfer function is relatively straightforward.

The “Just Noticeable Difference” (JND) represents the luminance difference of a given target under given viewing conditions that the average human observer can just perceive.

The JND values for the black and white luminance's including the effect of ambient are first determined

JNDₘᵢₙ=(L_{bl}·(T_{lcd}^{p=o})+Iₐ·Pₐ)·ƒ_{L=<JND}

and

JNDₘₐₓ=(L_{bl}·(T_{lcd}^{P=(2n-1)})+Iₐ·Pₐ)·ƒ_{L=<JND}

Where P this input date presentation value o to 2⁽ⁿ⁻¹⁾)

The required luminance transfer function can then be determined for 2ⁿ P values between JNDₘᵢₙ and JNDₘₐₓ

For this example the back light Luminance L_{bl} is fixed such that

(L_{bl}·(T_{lcd}^{P=(255)})=500 cd/m²

The presentation value has a range of 0 to 255 and the display data range 0 to 765 a bit depth overhead of 3 Dₘₐₓ/Pₘₐₓ.

The display is corrected by selecting 255 values from 765.

In order to implement automatic luminance correction Iₐ & L_{bl} are variables that would be monitored continuously. The Display LUT would be continuously updated ensuring that the display is continuously calibrated when the ambient illuminance changes.

With LCD displays there is a potential lifetime benefit if one limits the back light luminance. With very high brightness displays (may be this as much as 1500 cd/m²) it is interesting to calculate how much light is necessary to retain the optimum performance. Is it possible to have too much Light?

Assuming that we use all the available input data range of an LCD. The contrast ratio in terms of Luminance is constant, irrespective of back light luminance. This is not the case with CRT's where the black level setting has a large impact on the contrast ratio.

But because of the precise shape of the DICOM curve the number of JND's available for a given contrast ratio is not constant.

The graph FIG. 7 shows the situation for an LCD that has a fixed contrast ratio of 500:1 and a reflected luminance due to Iₐ of 1 cd/m² it is assumed that the display is corrected for DICOM grey scale function and that this is continually corrected for as described above.

Here the number of JND's per bit are plotted against white luminance assuming a bit depth of 8 bits.

Consider the following:

At a Lw=500 cd/m² the number of JND's/BIT reduces to 2.1 bearing in mind that we have just increased the illuminance by a factor of 4 this is not really to terrible.

Another constraint that we have to consider is that the black level must always be a few JND's above the reflected ambient to enable the first grey level to be seen. So how bright does that have to be?

The reflected luminance from the display due to the ambient illuminance is in the case 4 cd/m². If this is converted to the JND scail, this would be JND number 146. At least 1 JND is needed for the black level to be visible above the reflected ambient effects JND 147=4.06 cd/m².

Even with a white level of 200 cd/m² or LCD (CR=500) will have=0.4 cd/m². At this level people will clearly see the black level. In fact if we have a dark room <30 LUX and say a brightness of Lw=500 cd/m² the gap between the reflected ambient and L_{b} will be around 50 JND's this is big enough to generate complaints, since especially on modality images which traditionally have large areas of “black” background, this black background level is often perceived to be too bright.

So with an LCD display one would normally choose to control Lw (the white luminance) based on the required number of JND's over head for the black level. It would be unlikely to be necessary to control the black level unless LCD start to be made with >1000:1 contrast ratio. It would also seem to be not necessary to control the white luminance unless the displays are capable of generating a lot of light.

Note, in contrast, that with CRT's the contrast ratio is not fixed. Consider the general formula for the CRT gamma function:

L=(kₒ+kgD)^{γ}

In this formula kₒ essentially represents the “brightness” control and k_{g} is related to the contrast control and D represents the data in. If one requires the maximum contrast the value of kₒ must be set such that the black level is set to be just visible above the reflected luminance due to the ambient illuminance (La).

The graph of FIG. 8 shows the relationship between adjusting the black level and the contrast ratio assuming that the gain factor k_{g} remains constant. CRTs should be used with the lowest possible value kₒ. A CRT display would therefore be controlled such that the black level is kept at a fixed number of JND's above La. The gain k_{g} would only be controlled to facilitate matching of luminance of more than one monitor used together.

The basic requirement to enable the automatic compensation to be implemented in the ability to adjust the display look up table on the fly. The display system must also have the ability to continuously recalculate the LUT from the control data.

The display LUT can either be located in the host or the display. But to avoid quantisation errors bit depth bottlenecks must be avoided.

Referring to FIG. 9 of the drawings, there is illustrated schematically a self contained LCD implementation.

In this case, the monitor 10 is a self-contained self-calibrating DICOM compatible system running independent to the host 20. The bottleneck for bit depth is the transition of the image data to the monitor 10. All the processing 200 is contained within the monitor 10.

Thus, a digital video input signal from the host 20 is received by a receiver 12 and then fed, via a look-up-table (LUT) 14 to an LCD panel 16. Backlight luminance 18 from the LCD panel and an illuminance measurement for the ambient light sensor 22 is fed to a processor 200 which performs the desired ABC adjustment using, additionally, panel transmittance calibration data 24.

Referring to FIG. 10 of the drawings, there is illustrated a host controlled LCD implementation.

An image processing module 30 in the host 20 feeds image data to the LUT 14 (also in the host 20) and sub pixel data 32 therefrom is fed to the monitor 10. An ABC processing module 200a is provided in the host 20, with a serial hub 36 being provided between the ABC processing module 200a and the processor 200 in the monitor 10. Once again, the processor 200 uses the backlight luminance 18, illuminance measurement from the ambient light sensor 22 and panel transmittance calibration data 24 to generate control signals which are fed via the serial link 36 to the ABC processing module 200a in the host 20 to perform the necessary adjustments.

Thus, in this case, the sub pixel data is transmitted directly to the LCD pixels without any LUT actions with only just sufficient sailing to facilitate “boot up” practicalities. All display controls would be accomplished within the host 20 via a serial link. The processing only has to provide the control data, such as back light luminance and calibration data. The calibration data is panel dependent so should be stored with the panel.

An analogue (CRT) implementation would be possible with the system illustrated in FIG. 10, with analogue video supplied to the display.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. Apparatus for sensing illuminance of ambient light (112) falling on a display, said apparatus comprising a photo-sensitive device (100) located behind said display for receiving light falling on said display and generating an electric signal representative thereof, and a diffuser (110) located between a source (112) of said ambient light and said photo-sensitive device (100).

2. Apparatus according to claim 1, arranged and configured to conform substantially to the cosine effect whereby the illuminance on said display varies as the cosine of the angel of light incident thereon.

3. Apparatus according to claim 1, wherein said diffuser (110) is mounted in a substantially planar structure (103) behind which said photo-sensitive device (100) is located.

4. Apparatus according to claim 3, wherein said diffuser (110) is mounted proud (by a distance δ) relative to the surface of said planar structure (103).

5. Apparatus according to claim 4, wherein a substantially annular ring is provided around said photo-sensitive device (100) at a height δ relative thereto.

6. Apparatus according to claim 3, wherein said diffuser (110) is substantially flush relative to the surface of said planar structure (103).

7. Apparatus according to claim 1, wherein said diffuser (110) is located within an opaque tubular structure.

8. Apparatus according to claim 1, wherein said diffuser (110) is located generally centrally relative to a viewing area of said display.

9. A system for automatic illuminance control in respect of a display for displaying an image comprising a plurality of values representing pixel grey scale levels, said system comprising apparatus according to claim 1 for generating an electric signal representative of the illuminance of ambient light (112) falling on said display, and a control module (200a, 200) for adjusting the grey scale transfer function of said display so as to maintain calibration of a target grey scale transfer function.

10. A system according to claim 9, wherein said grey scale transfer function is adjusted substantially continuously.

11. A system according to claim 9, comprising means for receiving a digital video input signal defining said plurality of values, and said grey scale transfer function is adjusted by adjusting one or more of the backlight luminance and the look up table (LUT) of a digital display.

12. A display device comprising a display screen and a system according to claim 9.

13. A display device according to claim 12, comprising a liquid crystal display (LCD) device.

14. An image processor for use with a display screen for displaying an image comprising a plurality of values representing pixel grey scale values, said image processor (200) being arranged and configured to receive from apparatus according to claim 1 an electric signal representative of the illuminance of ambient light (112) falling on said display screen and further comprising a control module for adjusting the grey scale transfer function of said display screen so as to maintain calibration of a target grey scale transfer function.
